(19) United States
(12) Patent Application Publication
(10) Pub. No.: US 2004/0217189 A1
(43) Pub. Date: Nov. 4, 2004

(54) System and method for controlling irrigation

(75) Inventor: Phillip Regli, Lake Forest, CA (US)

Correspondence Address: Pillsbury Winthrop LLP, Intellectual Property Group, Suite 2800, 725 South Figueroa Street, Los Angeles, CA, 90017-5406, US

(73) Assignee: IRVINE RANCH WATER DISTRICT

(21) Appl. No.: 10/410,562

(22) Filed: Apr. 9, 2003

(51) Int. Cl. A01G 27/00

(52) U.S. Cl. 239/69

(57) ABSTRACT

A system and method for controlling irrigation for controlling irrigation including the transmission of an irrigation data signal including an irrigation instruction. The irrigation instruction may be calculated from various irrigation data including, but not limited to, landscape zone, sun radiation, root depth, soil condition, irrigation efficiency, water source, slope, curbside, evapotranspiration data, and any combination thereof. The system and method may further include the monitoring of irrigation flow and/or of a water meter.

### BACKGROUND

1. Technical Field

Embodiments of the present invention relate generally to controlling irrigation. More specifically, embodiments of the present invention relate to controlling irrigation by transmitting an irrigation instruction to an irrigation controller.

2. Discussion of the Related Art

U.S. citizens use approximately 35 billion gallons of water a day for household, industrial, and agricultural uses. Citizens in other countries obviously also use large volumes of water a day for similar uses. Water Conservation has become increasingly necessary as fresh water sources are limited and fully subscribed. Inefficient irrigation is an inappropriate use of water resources and results in runoff or non-point source pollution. Controlling irrigation is one method of saving water resources and reducing run off.

There are several types of irrigation controllers, both those that require human interaction and those that do not. Most of these controllers send an electric current to a remote sprinkler, causing the valve of the sprinkler to open. Usually, the valve is closed by discontinuing the supply of electric current. Most of these controllers can handle a number of valves, opening and closing them for programmed times on programmed days. This series of opening and closing valves is generally known as an “irrigation schedule” or an “irrigation program.” Many known controllers can store and execute more than one irrigation schedule.

Some of the types of irrigation controllers are as follows: There are controllers that are capable of executing an irrigation schedule but not capable of changing the schedule to account for variables such as changes in weather, slope or specific plant needs. Some controllers implement a rain sensor shut off. When the sensor detects that it is raining, the controller suspends irrigation until the rain stops or until the rain stops for a predetermined period of time. There are also more expensive controllers that can alter the frequency and amount of irrigation using an irrigation schedule based on historical weather data. These controllers generally take weather data over a number of years and average it into a yearly plan that can be used to create an average irrigation schedule. Even more expensive controllers accept Evapotranspiration (the loss of water by evaporation from the soil and transpiration from plants) data for the particular geographical area in which they are located, either broadcast to them or input manually, and calculate an irrigation schedule based upon this data.

### BRIEF DESCRIPTION OF THE DRAWINGS

FIG. 1 illustrates a system to control irrigation according to an embodiment of the present invention;

FIG. 2 illustrates a system to control irrigation according to an embodiment of the present invention;

FIG. 3 illustrates a system to control irrigation according to an embodiment of the present invention;

FIG. 4 illustrates a flow chart diagram of the operation of a system to control irrigation according to an embodiment of the present invention;

### DETAILED DESCRIPTION

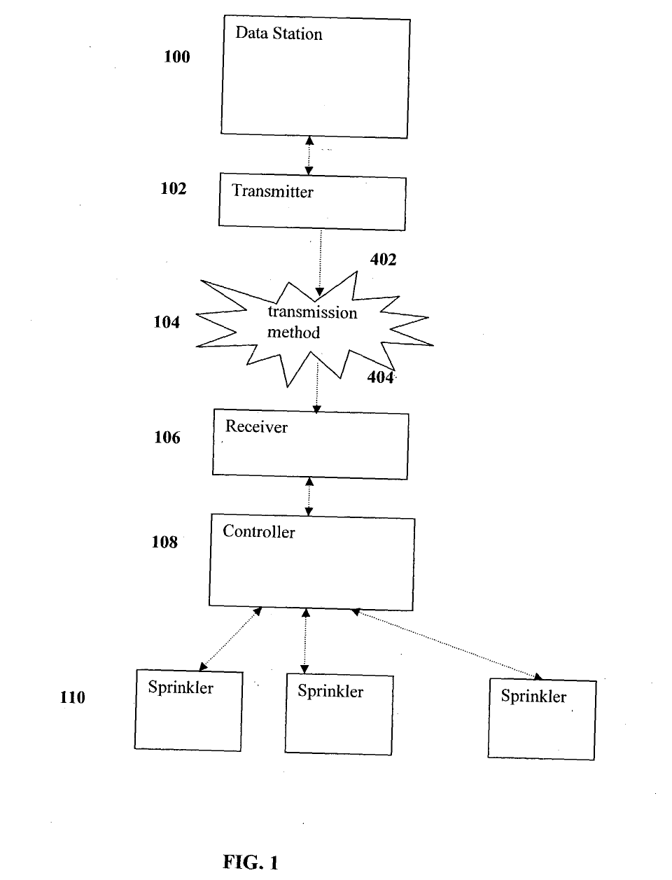

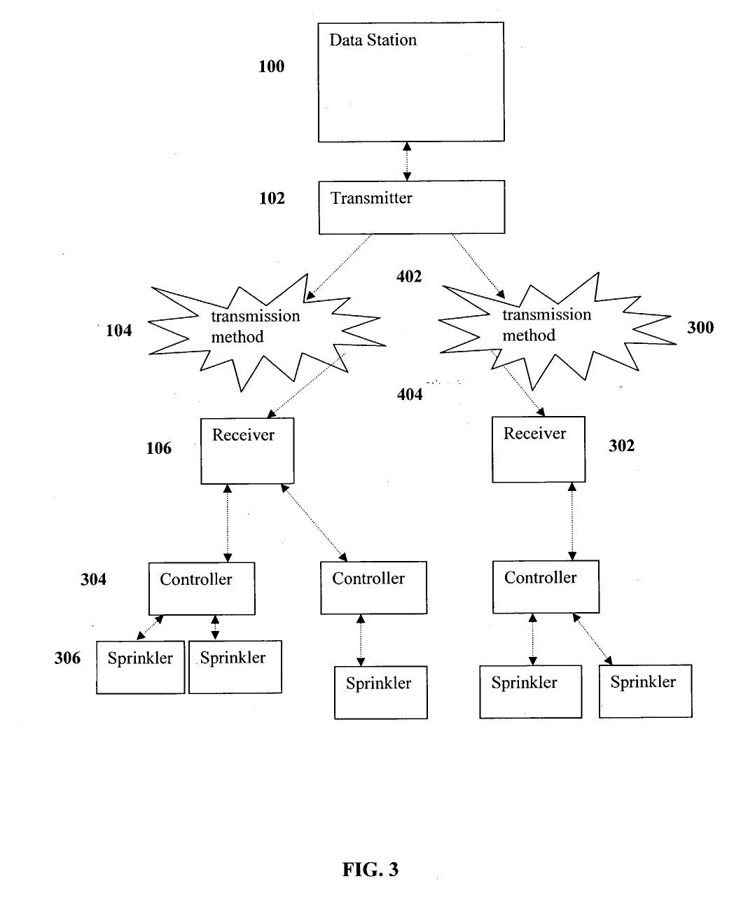

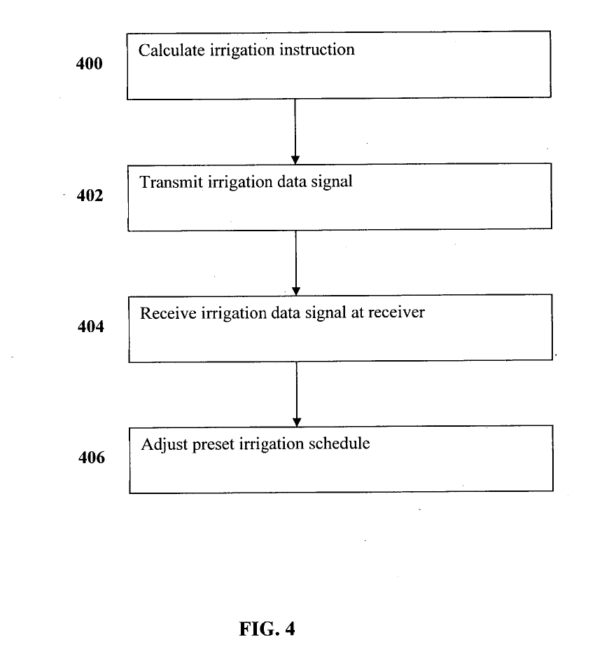

FIGS. 1-3 depict systems for controlling irrigation according to embodiments of the present invention and FIG. 4 depicts a flow chart diagram of the operation of a system according to an embodiment of the present invention. A data station 100 is in communication with a transmitter 102. The data station 100 may be a computer, network server, or any other type of apparatus or number of apparatuses that can perform calculations, store data, and communicate with a transmitter. A receiver 106 is in communication with at least one controller 108. FIG. 3 shows a system where a receiver 106 is in communication with more than one controller 304. It also shows a system where there is more than one receiver 106, 302, which are each in communication with at least one controller 304. The controller 108, or controllers 304, may communicate with one or more sprinklers 110, 306. The sprinklers 110, 306 may irrigate one or more types of crops or plants.

In an embodiment of the present invention, the transmitter 102 transmits at least one irrigation data signal 402 to the receiver 106. The irrigation data signal may be sent by any transmission method or medium 104, wireless, wired, or any combination thereof. The transmitter may also transmit more than one irrigation data signal. The transmitter may transmit one or more irrigation data signals in combination with other signals that may control other devices around a house or commercial building. When transmitting one or more irrigation data signals to one or more receivers, the transmitter may use the same or different transmission method 104, 300. Examples of transmission methods and medium include optical wireless transmission, radio frequency transmission, optical wire transmission, and electrical wire transmission, the Internet, electronic mail, a public or private telephone network, or any combination thereof. The irrigation data signal may be transmitted individually to each controller or to multiple controllers. The controllers of the present invention may be portable devices or may be adapted to be fixed to a certain location. They can be used in or at private homes, to control irrigation of lawns, plants, shrubs, and other foliage around the house, as well as to control pool water and watering of other outdoor items. They may also be connected to indoor water supplies. They can be used in large areas, such as golf courses, industrial areas, and the like to control irrigation and watering of all types of plants and other items that require water.

The irrigation data signal includes an irrigation instruction. The irrigation instruction is an instruction to a particular controller to increase or decrease the time of the irrigation and/or to increase or decrease the number of irrigation intervals. The irrigation instruction may also be sent to a plurality of controllers. It may be sent to the plurality of controllers at the same time or at different times. The irrigation instruction may be transmitted continually or intermittently. It may include an information instruction pertaining to a particular time period, such as a day, week or month, for example, increase the water time by some amount during the next week. It may include only an instruction to vary the water time and/or intervals in some way. It may include any other instruction to the controller. It may also include an instruction to turn the controller on or off. The irrigation instruction may be calculated from any of a variety of irrigation data including, but not limited to, landscape zone, sun radiation, root depth, soil condition, irrigation efficiency, water source, slope, curbside, and evapotranspiration data. The irrigation instruction may be calculated by the data station 100 or may be provided to the data station 100. The irrigation data may be obtained automatically by the data station 100 or may be entered in by a user.

Landscape zone is defined as the type of landscape or plant. Each landscape zone requires a different amount of water during the year. For example, types of zones could be turf zone (either high use or native use), shrubs zones depending on the type of shrub, tree zones dependent on the type of trees, and gardens/annuals zones depending on the type of plant.

Sun radiation is a measurement of how much sun the area being irrigated is obtaining. This number would differ depending on whether it is shady or sunny, what time of year it is, and what the location is. The sun radiation could be measured in a number of different ways, including at the individual controller site, taken as an average of historical sun radiation in that area, or calculated from a combination of the sun radiation for that area and adjustments for how much shade the particular area is getting.

Root depth is a measurement of the average depth of a root and is generally dependent upon the type of plant being irrigated. It could also be measured at the site of irrigation.

Soil condition is a measurement of the penetration rate for irrigation to reach the root zone. For example, sandy soil has a high penetration rate, while clay has a very low penetration rate. Each type of soil may have its own soil condition value. Soil types generally range from clay to sand with various degrees of mixture between them.

Irrigation efficiency is a measurement of how efficient the type of sprinkler used at the irrigation area is. For example, a bubbler sprinkler is extremely efficient and would have a value of around 100%, while a poor spray head would have a lower value. A poor spray head can be as bad as 0% efficient, but a spray head generally has an efficiency of around 65%.

Water source is a value indicating the types of water available to the irrigation area. This would take into account whether there is only irrigation available or whether there is other water, such as rivers, lakes, or groundwater.

Slope is a measurement of the slope of the area, generally 0 to 50 degrees. A higher slope generally causes higher runoff and less efficient irrigation.

Curbside is a binary measurement indicating whether the irrigation area is next to concrete or other non-soil land coverings, causing extra runoff. Alternatively, curbside could have a range of values indicating what portion of the area being irrigated is next to concrete.

Evapotranspiration is a measurement of the amount of water being lost from the plant by evaporation and transpiration. It can be measured from a variety of equations and can be measured locally or obtained from weather stations.

Once the data station 100 has calculated the irrigation instruction 400, the transmitter 102 transmits the irrigation data signal 402 to the receiver 106. A receiver according to an embodiment of the present invention may transmit one or more irrigation data signals to a plurality of controllers. The receiver 106, communicating with the controller 108, receives the irrigation data signal 404. The controller 108 then follows the irrigation instruction received, changing time to irrigate and/or irrigation intervals in order to adjust the present irrigation schedule 206. The irrigation instruction may be to do nothing, in which case the controller 108 will not change its preset irrigation schedule. The irrigation data signal may be sent periodically, such as hourly, daily or weekly. It may include a time and/or date at which to control irrigation or to stop controlling irrigation. The controller may poll or request one or more irrigation instructions from the data station. This polling or requesting may or may not occur in combination with receiving irrigation instructions without polling or requesting them.

In an embodiment of the present invention, the irrigation data signal may include a data combination identifier. There are a limited number of combinations of the above irrigation data. Each data combination may be assigned a number from 1-n, where n is the total number of data combinations. In an embodiment of the present invention, each irrigation area controlled by a controller is assigned its data combination identifier. This may be determined by the controller itself, by the data station, or by a user.

A controller according to an embodiment of the present invention contains one or more preset irrigation schedules. The preset irrigation schedule may be based upon historical irrigation data for the particular location of the controller. It may also be based upon historical irrigation data for the particular data combination identifier. Alternatively, it may be based upon times of the day and week that would be preferable to irrigate or any other basis. It may be set by the user or automatically calculated by the controller or the data station.

If the irrigation data signal includes a data combination identifier, the receiver or controller may identify the data combination identifier to determine whether a corresponding irrigation instruction applies to that controller. The receiver may wait for the correct irrigation data combination identifier to communicate the corresponding irrigation instruction to the controller. Alternatively, the receiver may pass on to the controller an entire spreadsheet or table or the like of data including all data combination identifiers and corresponding irrigation instructions and determine which irrigation instruction(s) applies to it.

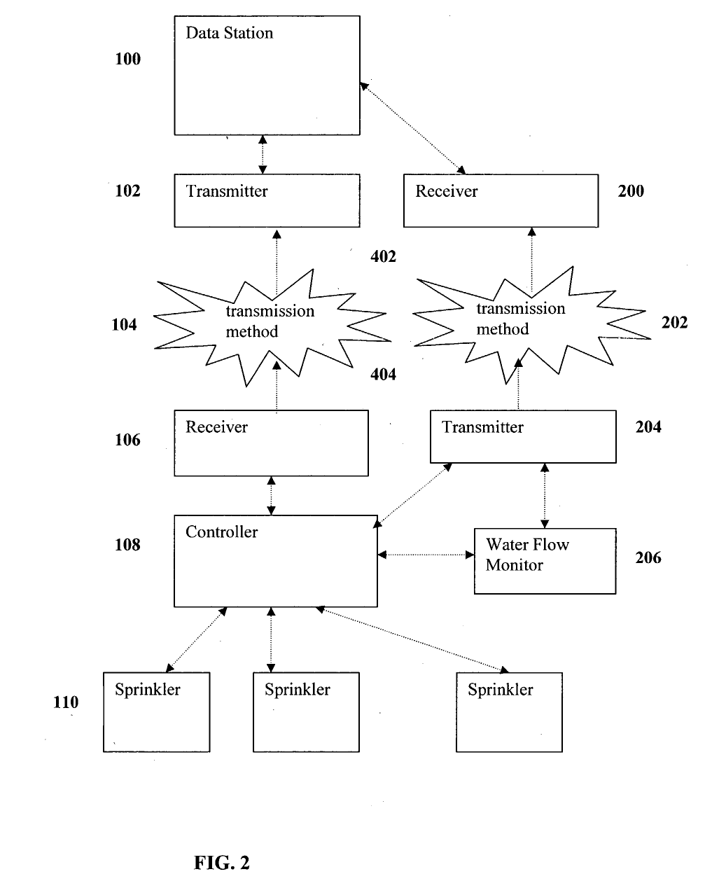

In another embodiment of the present invention, shown in FIG. 2, the controller 108 is in communication with a second transmitter 204 and the data station 100 is in communication with a second receiver 200. The second transmitter 204 may transmit data to the second receiver 200 by the same or different transmission method 104, 202 as is used by the transmitter 102. The second transmitter 204 may transmit a controller information message to the second receiver 200. The controller information message may comprise any data about the status of the controller, including the data combination identifiers present in the controller, whether a valve is stuck, whether the receiver 106 communicating with the controller 108 is not receiving information, whether the controller 108 is receiving incorrect instructions, how much water the controller 108 is telling the sprinklers 110 to use, or any other data about the controller 108. When the second receiver 200 receives the controller information message and communicates it to the data station 100, the data station 100 may automatically correct any problems or make adjustments based on the data. Also, a user may review controller information messages to determine whether there are any problems with the system. The user may review the controller information message on a computer or server in communication with the data station or directly at the data station. The computer or server may be any type, including but not limited to ones for home use or business use. The computer or server may communicate with the data station over an intranet, over the Internet, by electronic mail, by radio transmission, by any other form for local remote pick-up, or any other transmission method or medium, or any combination thereof.

In an embodiment of the present invention also shown in FIG. 2, the controller 108 communicates with a water flow monitor 206. The water flow monitor may also communicate directly with the second transmitter 204. The water flow monitor 206 may constantly monitor a water meter to determine whether there is a leak or any other problem with the irrigation system or with any other water system attached to the water meter. The water flow monitor 206 may include a flow sensor device, which can be a magnetic sensor connected to the water meter face to track movement on the meter arm or a flow motion sensor that detects the flow of water. A measured signal is communicated to the second transmitter 204 through the controller 108 and transmitted to the second receiver 200 as the controller information message. The controller information message may be sent constantly or periodically. When the second receiver 200 receives the controller information message and communicates it to the data station 100, the data station 100 may automatically correct any problems or make adjustments based on the data. Also, a user of the data station 100 may review controller information messages to determine whether there are any problems with the system. In an alternate embodiment, the controller 108 may be programmed to make a warning signal, such as a light or sound, based on certain controller information messages or measured signals from the water flow monitor 206.

In another embodiment of the present invention there is provided a method of controlling irrigation of one or more remote controllers by transmitting an irrigation data signal including an irrigation instruction to one or more receivers. These receivers are in communication with one or more controllers. The controllers may be portable or adapted to be fixed to a location. The controllers may be located in a private home or a public location. In this embodiment, one data station may be used to control and monitor irrigation of a wide area of homes and public location. Of course, this method could also be used to control and monitor irrigation at only one location or home. This embodiment may be used in combination with any or all of the embodiments above.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein

What is claimed is:

1. A method of controlling irrigation, comprising:
transmitting an irrigation data signal;
receiving the irrigation data signal; and
adjusting a preset irrigation schedule based upon the irrigation data signal to provide an adjusted irrigation schedule,
wherein the irrigation data signal includes an irrigation instruction.

2. The method of claim 1, wherein each of the steps of the method are performed automatically.

3. The method of claim 1, wherein the irrigation instruction is selected from the group consisting of a time instruction, an interval instruction, and a time instruction and an interval instruction.

4. The method of claim 1, further comprising:
calculating the irrigation instruction from irrigation data.

5. The method of claim 4, wherein the irrigation data is selected from the group consisting of landscape zone, sun radiation, root depth, soil condition, irrigation efficiency, water source, slope, curbside, evapotranspiration data, and any combinations thereof.

6. The method of claim 1, wherein the irrigation data signal further includes a data combination identifier.

7. The method of claim 6, further comprising identifying the data combination identifier.

8. The method of claim 1, further comprising calculating the preset irrigation schedule from historical irrigation data.

9. The method of claim 1, further comprising:
monitoring an irrigation flow;
transmitting an water flow message;
and receiving the water flow message.

10. The method of claim 1, further comprising monitoring a water meter, transmitting a water meter message, and receiving the water meter message.

11. The method of claim 1, wherein the irrigation data signal is transmitted via a method including transmission over the Internet.

12. The method of claim 1, wherein the irrigation data signal is transmitted via a method selected from the group consisting of optical wireless transmission, radio frequency transmission, optical wire transmission, electrical wire transmission, or a combination thereof.

13. A method of controlling irrigation comprising:
receiving an irrigation data signal; and
adjusting a preset irrigation schedule based upon the irrigation data signal to provide an adjusted irrigation schedule, wherein the irrigation data signal includes an irrigation instruction.

14. The method of claim 13, wherein the irrigation instruction is calculated from irrigation data selected from the group consisting of landscape zone, sun radiation, root depth, soil condition, irrigation efficiency, water source, slope, curbside, evapotranspiration data, and any combinations thereof.

15. A method of controlling irrigation, comprising:
determining an irrigation instruction from irrigation data, and
transmitting an irrigation data signal including the irrigation instruction to a receiver in communication with a controller.

16. The method of claim 15, irrigation data is selected from the group consisting of landscape zone, sun radiation, root depth, soil condition, irrigation efficiency, water source, slope, curbside, evapotranspiration data, and any combinations thereof.

17. A system for controlling irrigation comprising:
a data station;
a first transmitter in communication with the data station,
a first receiver in communication with the first transmitter; and
one or more controllers in communication with the receiver, wherein the first transmitter is adapted to transmit an irrigation data signal including an irrigation instruction to the first receiver.

18. The system of claim 17, wherein the one or more controllers are in communication with at least one sprinkler.

19. The system of claim 17, further comprising at least one additional receiver in communication with the first transmitter and in communication with at least one of the one or more controllers.

20. The system of claim 17, further comprising at least one additional transmitter in communication with the first receiver and in communication with the data station.

21. The system of claim 17, wherein the irrigation instruction is calculated from irrigation data selected from the group consisting of landscape zone, sun radiation, root depth, soil condition, irrigation efficiency, water source, slope, curbside, evapotranspiration data, and any combinations thereof.

22. The system of claim 21, wherein the irrigation instruction further includes a data combination identifier.

23. The system of claim 17, further comprising, a second transmitter in communication with the controller, and a second receiver in communication with the data station, wherein the second transmitter is adapted to transmit a controller information message to the second receiver.

24. The system of claim 23, wherein the controller information message includes a data combination identifier.

25. The system of claim 23, wherein the water flow monitor comprises a flow sensor device coupled to a water meter.

26. The system of claim 25, wherein the flow sensor device is a magnetic sensor to track movement of the water meter's arm.

27. The system of claim 25, wherein the flow sensor device is a flow motion sensor.

28. A system for controlling irrigation comprising:
means for transmitting an irrigation data signal;
means for receiving the irrigation data signal; and
means for adjusting a preset irrigation schedule based upon the irrigation data signal to provide an adjusted irrigation schedule, wherein the irrigation data signal includes an irrigation instruction.

29. The system of claim 28, wherein the irrigation instruction is calculated from irrigation data selected from the group consisting of landscape zone, sun radiation, root depth, soil condition, irrigation efficiency, water source, slope, curbside, evapotranspiration data, and any combinations thereof.

30. The method of claim 28, wherein the irrigation data signal further includes a data combination identifier.

31. A method of controlling irrigation of one or more remote controllers for irrigation comprising:
determining an irrigation instruction from irrigation data;
transmitting an irrigation data signal including the irrigation instruction to one or more receivers, wherein the one or more receivers are in communication with one or more controllers;
receiving the irrigation data signal; and
adjusting a preset irrigation schedule based upon the irrigation data signal to provide an adjusted irrigation schedule.

32. The method of claim 31, wherein the one or more controllers are portable.

33. The method of claim 31, wherein the irrigation data is selected from the group consisting of landscape zone, sun radiation, root depth, soil condition, irrigation efficiency, water source, slope, curbside, evapotranspiration data, and any combinations thereof.

34. The method of claim 31, further comprising monitoring the one or more controllers.

35. The method of claim 34, further comprising receiving one or more controller information messages about at least one of the one or more controllers.

36. The method of claim 35, further comprising adjusting the irrigation instruction based upon the one or more controller information messages.

37. The method of claim 31 wherein at least two of the receivers and at least two of the controllers are located at private residences.

38. The method of claim 37 wherein each of the at least two controllers are each in communication with at least two sprinklers.

39. The method of claim 38 wherein each of the at least two controllers also are utilized to control non-irrigation water levels.

40. The method of claim 38 wherein each of the at least two controllers also are utilized to control pool water levels.

41. The method of claim 37, wherein the irrigation data signal is transmitted via a method including transmission over the Internet.

42. The method of claim 31, wherein the method is practiced for the benefit of local residents of a water district.

43. The method of claim 42, wherein the water district charges a fee from the local residents for practicing the method.
